(19) United States
(12) Patent Application Publication
(10) Pub. No.: US 2012/0085199 A1
(43) Pub. Date: Apr. 12, 2012

(54) DRIVE SYSTEM FOR A MOTOR VEHICLE, METHOD FOR OPERATING A DRIVE SYSTEM OF THIS KIND AND MOTOR VEHICLE HAVING A DRIVE SYSTEM OF THIS KIND

(75) Inventors: Nils Sauvlet, Rutesheim (DE); Henrik Schrage, Weinsberg (DE); Leo Spiegel, Vaihingen/Enz (DE); Martin Füchtner, Stuttgart (DE); Stephan Müller, Leonberg (DE)

(73) Assignee: Dr. Ing. h.c.F. Porsche Aktiengesellschaft, Stuttgart (DE)

(21) Appl. No.: 13/249,400

(22) Filed: Sep. 30, 2011

(30) Foreign Application Priority Data
Oct. 11, 2010 (DE) 102010038086.5

(51) Int. Cl. F16H 37/06; B60K 6/48

(52) U.S. Cl. 74/665 B; 290/45; 180/65.25; 903/902

(57) ABSTRACT

A drive system for a motor vehicle, having an internal combustion engine; and an electric machine operatively connected to the internal combustion engine, the electric machine taking the switched-off internal combustion engine along in a purely electric operating state of the drive system. Also disclosed is a method for operating a drive system for a motor vehicle, the drive system having an internal combustion engine and an electric machine operatively connected to the internal combustion engine, and the electric machine taking the switched-off internal combustion engine along in a purely electric operating state of the drive system. Also disclosed is a motor vehicle having a drive system of this kind.

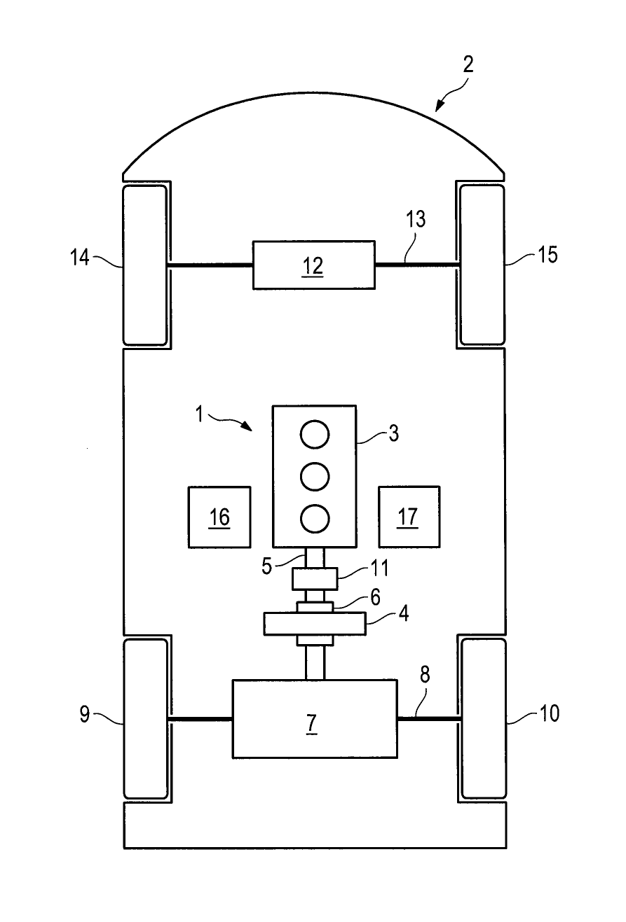

The present invention relates to a drive system for a motor vehicle, a method for operating a drive system of this kind and to a motor vehicle having a drive system of this kind.

Although it can be used on any vehicle, the present invention and the problems underlying said invention will be explained in detail with reference to a passenger car.

An electric driving mode on a motor vehicle having a hybrid drive is generally implemented by switching off the internal combustion engine and separating it from the remainder of the drive system by means of a separating clutch, which is designed as a friction clutch, for example. The electric machine alone drives the motor vehicle via a transmission. In the case of hybrid vehicles having a separate electric final drive, switching off the internal combustion engine and shifting the transmission to neutral is sufficient for electris operation. The motor vehicle is then driven at the axle by means of the independent electric machine. On sports vehicles with high power requirements, the driving power must be assigned to both driven axles.

DE 10 2007 019 988 A1 describes a passenger car with all-wheel drive having a first and a second driven axle and a hybrid drive for the two driven axles, the hybrid drive comprising a combination of an internal combustion engine and a single electric machine, which is coupled to the crankshaft of the internal combustion engine and which drives the first driven axle via a transmission. The hybrid drive comprises a further electric machine, which acts directly on a second driven axle, which is driven by the further electric machine in at least one operating state. In purely electric driving mode, the electric machine coupled to the crankshaft of the internal combustion engine is decoupled from the internal combustion engine, or the internal combustion engine and the electric machine associated therewith are jointly decoupled from the driven axle and electric driving is performed by means of the further electric machine alone.

DE 10 2008 058 624 A1 describes a method for controlling the distribution of torque contributions of a number of sources of torque coupled to different drivetrains of a motor vehicle to give a total torque acting on the motor vehicle, wherein a central control unit that coordinates the total torque communicates with a number of individual control units directly controlling the individual sources of torque. Before each change in the distribution of the torque contributions, the central control unit indicates to each individual control unit the torque contribution envisaged for the source of torque associated with this individual control unit, each individual control unit controls the source of torque associated therewith in order to prepare for the coupling in of the envisaged torque contribution thereof, and the associated source of torque indicates to the central control unit that it is ready to couple in the envisaged torque contribution thereof as soon as it is ready.

It has proven disadvantageous with these arrangements that the drive system obtained is either highly complex and very heavy or that a purely electric driving mode is only possible by driving one axle. It is not possible by this means to meet the requirements of a sports vehicle for high power development with a simultane— ously low weight. As will be understood, this is something to be avoided.

It is the underlying object of the invention to provide an improved drive system.

According to the invention, this object is achieved by a drive system having the features of patent claim 1 and/or by a method having the features of patent claim 8.

Accordingly, the invention provides a drive system for a motor vehicle, having: an internal combustion engine; and an electric machine operatively connected to the internal combustion engine, the electric machine taking the switched-off internal combustion engine along in a purely electric operating state of the drive system.

The invention furthermore provides a method for operating a drive system for a motor vehicle, the drive system having an internal combustion engine and an electric machine operatively connected to the internal combustion engine, and the electric machine taking the switched-off internal combustion engine along in a purely electric operating state of the drive system.

Given a fixed connection between the internal combustion engine and the electric machine, this makes it possible to transmit the driving power of the electric machine to the driven axle in a purely electric driving mode of the drive system. In comparison with attempted solutions which have been described, this results in reduced complexity and a reduced weight of the drive system.

Advantageous embodiments and improvements of the drive system specified in patent claim 1 and of the method specified in patent claim 8 can be found in the subclaims.

According to a preferred development, the internal combustion engine and the electric machine are operatively connected to a driven axle. For driving a motor vehicle with a drive system of this kind, this advantageously makes it possible to transmit the driving power of the internal combustion engine and of the electric machine to the driven axle.

According to another preferred illustrative embodiment, the electric machine is operatively connected directly to a crankshaft of the internal combustion engine. This results in rigid and easy coupling of the electric machine to the internal combustion engine.

According to a preferred embodiment, the drive system has a further electric machine, which is operatively connected, in particular, to a further driven axle.

This makes possible electric all-wheel driving of a motor vehicle with a drive system of this kind.

According to another preferred development, the drive system has a transmission, in particular a dual clutch transmission. This provides an advantageous way of transmitting the drive torque of the internal combustion engine, resulting in reduced fuel consumption.

According to another preferred embodiment, the transmission is arranged between the electric machine and the driven axle. As a result, the drive torque of the electric machine can advantageously be transmitted to the driven axle at a desired transmission ratio.

According to another preferred development, a decoupling element, in particular a positive clutch, is arranged between the internal combustion engine and the electric machine for the purpose of decoupling the electric machine from the internal combustion engine. This makes it possible to decouple the internal combustion engine from the electric machine, in recuperation mode for example, thereby making it unnecessary to take along the internal combustion engine. As a result, the internal combustion engine does not produce any drag torque. This increases the efficiency of the drive system.

According to a preferred embodiment, the electric machine drives one driven axle of the motor vehicle and a further electric machine drives a further driven axle of the motor vehicle in the purely electric operating state of the drive system, thereby allowing electric all-wheel driving of a motor vehicle having a drive system of this kind.

The invention is explained in greater detail below by means of illustrative embodiments with reference to the attached schematic FIGURE of the drawing.

The attached FIGURE shows a motor vehicle having a preferred embodiment of a drive system in a plan view.

The FIGURE illustrates a preferred embodiment of a drive system 1 for a motor vehicle 2 in a plan view. The drive system 1 preferably has an internal combustion engine 3 and a first electric machine 4. The first electric machine 4 is preferably operatively connected directly to a crankshaft 5 of the internal combustion engine 3. For example, a rotor 6 or an output shaft 6 of the first electric machine 4 is operatively connected, nonpositively, materially and/or positively, to the crankshaft 5. The first electric machine 4 is designed as an axially parallel electric machine, the rofor 6 of which is arranged parallel to the crankshaft 5, or as a disk-type electric machine which surrounds the crankshaft 5, at least in sections. The first electric machine 4 is preferably mounted directly on the internal combustion engine 3. The first electric machine 4 is arranged, in particular, between the internal combustion engine 3 and a transmission 7 of the drive system 1. The internal combustion engine 3, the first electric machine 4 and the transmission 7 are preferably arranged in a rear area of the motor vehicle 2. The first electric machine 4 is preferably designed for operation both as an electric motor and as a generator.

The transmission 7 is preferably designed as a shift transmission 7, in particular as an automated shift transmission 7. For example, the transmission 7 is designed as a dual clutch transmission 7. The transmission 7 is used to convert a driving power of the internal combustion engine 3 and/or of the first electric machine 4 and to transfer the driving power to a driven axle 8 of the motor vehicle 2. For this purpose, the transmission 7 has a differential for transferring the driving power of the internal combustion engine 3 and/or of the first electric machine 4 to the driven axle 8 of the drive system 1, for example. The driven axle 8 is preferably designed as the rear axle 8 of the motor vehicle 2 and is used to drive wheels 9, 10, in particular rear wheels 9, 10, of the motor vehicle 2. By means of the transmission 7, the internal combustion engine 3 and/or the first electric machine 4 can be operatively connected to the driven axle 8 and, given an appropriate shift position, in particular a neutral position, of the transmission 7, can also be decoupled from said axle.

As an option, a decoupling element 11 can be provided between the internal combustion engine 3 and the first electric machine 4, although this decoupling element is not designed as a starting clutch. The decoupling element 11 can be designed as a positive clutch 11, for example.

The drive system 1 furthermore has a second electric machine 12, for example, which is, in particular, operatively connected to a second driven axle 13, in particular a front axle 13 of the motor vehicle 2. As with the first electric machine 4, the second electric machine 12 can be designed as an axially parallel electric machine or as a disk-type electric machine. The second electric machine 12 is preferably designed for operation as an electric motor and as a generator. The driven axle 13 is used to drive wheels 14, 15, in particular front wheels 14, 15, of the motor vehicle 2. As an alternative, the drive system 1 can also have two second electric machines 12, one of the two electric machines 12 preferably being assigned to each wheel 14, 15.

The operation of the drive system 1 is explained below. During a purely electric driving mode of the motor vehicle 2 having a drive system 1 of this kind with the two electric machines 4, 12, the internal combustion engine 3 is always taken along by the first electric machine 4 owing to the fixed connection between the first electric machine 4 and the crankshaft 5 of the internal combustion engine 3. This means that a supply of fuel to the internal combustion engine 3 is interrupted and ignition of the internal combustion engine 3 is switched off. The first electric machine 4 takes along the crankshaft 5 of the internal combustion engine 3 in rotation. As a result, both electric machines 4, 12 can be used to drive both driven axles 8, 13 of the motor vehicle 2. In this case, the first electric machine 4 produces a drag power for the internal combustion engine 3. The omission of a starting clutch with a corresponding actuating system and a necessary control system between the first electric machine 4 and the internal combustion engine 3 makes the drive system 1 significantly lighter, less costly and less complex than drive systems already described, while developing the same or greater power. Moreover, control of the drive system 1 without a driving clutch of this kind between the internal combustion engine 3 and the first electric machine 4 is significantly simpler and more robust owing to the fixed connection between the first electric machine 4 and the internal combustion engine 3.

As an alternative, it is also possible for the motor vehicle 2 to be driven purely electrically by the second electric machine 12 alone if the power requirements are relatively low. In this case, only the front axle 13 of the motor vehicle 2 is driven. By means of the transmission 7, the internal combustion engine 3 and the first electric machine 4 are decoupled from the driven axle 8 in the case of an appropriate shift position, in particular the neutral position, of the trans-mission 7. In this operating state, no drag power from the first electric machine 4 is required to take the internal combustion engine 3 along. In this operating state of the drive system 1, for example, the internal combustion engine 3 can drive the first electric machine 4 as a generator in order to produce electrical energy.

When the drive system 1 is being operated by means of the internal combustion engine alone, the second electric machine 12 can be decoupled from the front driven axle 13 by means of a clutch device (not shown), for example, and the internal combustion engine 3 operates the first electric machine 4 as a generator, in order to charge an energy storage device 16, for example.

In a combined operating state of the drive system 1 using an electric motor or motors/the internal combustion engine, the first and/or the second electric machine 4, and the internal combustion engine 3 cumulatively apply a particular driving power to the corresponding driven axle 8, 13.

In a recuperation mode of the drive system 1, the internal combustion engine 3 is switched off, for example, and the kinetic energy of the motor vehicle is converted by means of the electric machines 4, 12 to electrical energy, which is stored in the energy storage device 16, for example, in particular in a battery 16. In this case, the internal combustion engine 3 acts as an engine brake for additional deceleration of the motor vehicle 2. If reduced deceleration of the motor vehicle 2 is required, the internal combustion engine 3 and the first electric machine 4 can be decoupled from the rear axle 8 of the motor vehicle by means of the transmission 7 and, as a result, only the second electric machine 12 converts kinetic energy of the motor vehicle 2 into electrical energy.

Since the internal combustion engine 3 is taken along by the first electric machine 4 at all times in the purely electric driving mode, there is the possibility of a very rapid resumption of power from the internal combustion engine 3 from the purely electric driving mode. This is advantageous, for example, in the case of rapid acceleration processes or “SOC” (State of Charge) requirements of the battery 16 of the motor vehicle 2. During purely electric driving, the electric machines 4, 12 consume electrical energy from the battery 16 of the motor vehicle 2. As soon as a controller 17 of the drive system 1 registers the fact that the charge condition of the battery 16 requires charging of the battery 16, the internal combustion engine 3 can be switched to charge the battery 16, for example, merely by injecting fuel and switching on the ignition.

Since the internal combustion engine 3 corotates with the first electric machine 4 at all times, all that is required at the transition from the purely electric driving mode to the driving mode involving the electric motor(s)/internal combustion engine or the internal combustion engine alone is to activate the fuel injection system of the internal combustion engine 3 and to switch on the ignition of the internal combustion engine 3. It is not necessary to accelerate the internal combustion engine 3 in order to start it. As a result, there is a very rapid, jerk-free transition from the purely electric to the electric/internal combustion engine mode of the drive system 1.

Given an appropriate shift position of the transmission 7, in particular the neutral position of the transmission 7, the internal combustion engine 3 can be set in rotation and started by means of the first electric machine 4 in order to carry out a cold start.

Given an appropriate shift position of the transmission 7, i.e. given decoupling of the driven axle 8 from the transmission 7, it is furthermore likewise possible for the internal combustion engine 3 to drive the first electric machine 4 as a generator, for stationary charging of the battery 16, for example.

1.-10. (canceled)

11. A drive system for a motor vehicle comprising:
an internal combustion engine; and
an electric machine operatively connected to the internal combustion engine, the electric machine being conFIGUREd to take a deactivated internal combustion engine along in a purely electric operating state of the drive system.

12. The drive system as claimed in claim 11, wherein the internal combustion engine and the electric machine are operatively connected to a driven axle of the motor vehicle.

13. The drive system as claimed in claim 11, wherein the electric machine is operatively connected directly to a crankshaft of the internal combustion engine.

14. The drive system as claimed in claim 11 further comprising a further electric machine, which is operatively connected to a further driven axle of the motor vehicle.

15. The drive system as claimed in claim 11, wherein the drive system has a transmission.

16. The drive system as claimed in claim 15, wherein the transmission is a dual clutch transmission.

17. The drive system as claimed in claim 15, wherein the internal combustion engine and the electric machine are operatively connected to a driven axle of the motor vehicle, and wherein the transmission is arranged between the electric machine and the driven axle.

18. The drive system as claimed in claim 11, wherein a decoupling element is arranged between the internal combustion engine and the electric machine for the purpose of decoupling the electric machine from the internal combustion engine.

19. The drive system as claimed in claim 18, wherein the decoupling element is a positive clutch.

20. A motor vehicle having a drive system as claimed in claim 11.

21. A method for operating a drive system for a motor vehicle, the drive system having an internal combustion engine and an electric machine operatively connected to the internal combustion engine, said method comprising the step of taking a deactivated internal combustion engine along in a purely electric operating state of the drive system.

22. The method as claimed in claim 21, wherein in the purely electric operating state of the drive system, the electric machine drives one driven axle of the motor vehicle and a further electric machine drives a further driven axle of the motor vehicle.

23. The method as claimed in claim 21, wherein the step of taking a deactivated internal combustion engine along in a purely electric operating state of the drive system comprises operating the electric machine to drive an axle of the motor vehicle and rotate a crankshaft of the internal combustion engine while the internal combustion engine is deactivated.
